(19) United States
(12) Patent Application Publication
(10) Pub. No.: US 2017/0330644 A1
(43) Pub. Date: Nov. 16, 2017

(54) CHARGING CABLE HAVING FLEXIBILITY AT LOW TEMPEATURE AND OIL RESISTANCE

(71) Applicants: Hyundai Motor Company, Seoul (KR); Kia Motors Corporation, Seoul (KR); Kyungshin Cable Co., Ltd., Cheonan (KR)

(72) Inventors: Yun Jae Jung, Suwon (KR); Jung Woo Park, Cheonan (KR); Seong Geun Park, Cheonan (KR)

(21) Appl. No.: 15/349,124

(22) Filed: Nov. 11, 2016

(30) Foreign Application Priority Data
May 13, 2016 (KR) 10-2016-0059123

(51) Int. Cl. H01B 3/44; H01B 7/04; H01B 3/30; C09D 153/02; B60L 11/18; C09D 153/00; C09D 123/16; C09D 123/02; C09D 5/18; H01B 7/295; C09D 175/06

(52) U.S. Cl. CPC H01B 3/441; H01B 7/295; H01B 7/04; H01B 3/307; H01B 3/302; C09D 175/06; B60L 11/1809; C09D 153/00; C09D 123/16; C09D 123/02; C09D 5/18; C09D 153/02

(57) ABSTRACT

A charging cable is provided. The charging cable includes wires for supplying power, a wire for transferring a signal and a sheath, and exhibits substantially improved mechanical properties such as low-temperature flexibility and abrasion resistance, substantially improved chemical properties such as oil resistance and substantially improved electrical properties such as insulation resistance. Moreover, the charging cable has improved electrical, mechanical and chemical properties by improving insulation resistance, heat resistance and low-temperature flexibility of wires, as compared to conventional wires coated with polyvinylchloride (PVC).

### CROSS-REFERENCE TO RELATED APPLICATION

This application claims under 35 U.S.C. §119(a) the benefit of priority to Korean Patent Application No. 10-2016-0059123 filed on May 13, 2016, the entire contents of which are incorporated herein by reference.

### TECHNICAL FIELD

The present invention relates to a charging cable which includes wires configured to supply power, a wire configured to transfer a signal and a sheath. The charging cable of the invention may have substantially improved mechanical properties such as low-temperature flexibility and abrasion resistance, substantially improved chemical properties such as oil resistance and substantially improved electrical properties such as insulation resistance as compared to conventional wires coated with polyvinylchloride (PVC), by suitably using novel coating compositions and resins.

### BACKGROUND

In general, in accordance with global strengthening of environmental regulations and energy saving, development and supply of eco-friendly vehicles have been gradually spreading over the world. In accordance with supply of electric vehicles, there is demand for expansion of charging stations and supply of charging cables.

Charging an electric vehicle can start when a charging cable mounted on the electric vehicle is connected to the electric vehicle and a charging stand at a charging station. Such an electric vehicle charging system requires high flexibility and safety against various vehicle oils because a user should carry the charging cable and use the charging cable such in a manner to mount the same on the electric vehicle. Furthermore, charging electric vehicles for a long time under below zero environments may cause problems of cold resistance and flexibility.

Accordingly, there is a need for charging cables which are convenient to users and exhibit excellent flexibility, oil resistance, mechanical properties and flame retardancy. In accordance with the eco-friendly trend, materials may be eco-friendly flame retardant systems.

In addition, since wire manufacturers have improved production efficiency by making an extrusion speed of wires as high as possible, coating materials for vehicle wires should satisfy extrusion processability as well as the aforementioned properties.

Meanwhile, brominated flame retardants (DBDPO), which impart superior flame retardancy to polymers used for wires, may release dioxin-generating substances and use thereof is thus prohibited in some European nations. Instead, metal hydroxides such as aluminum hydroxide (Al(OH)₃) or magnesium hydroxide (Mg(OH)₂) or phosphorous-based flame retardants may be used as halogen-free materials.

Taking into consideration the global trend toward restriction of substances affecting the environment such as halogen and heavy metals, halogen-free flame retardants have been encouraged to use. In addition, there is an urgent need for compositions for development of eco-friendly compositions for wire coating having excellent low-temperature flexibility, oil resistance and mechanical properties, and charging cables using the same.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention may provide coating compositions, which may be respectively used for producing a charging cable including a wire for supplying power, a wire for transferring a signal and a sheath. As such, oil resistance, insulation resistance, heat resistance, low-temperature flexibility, mechanical properties and the like of the charging cables may be substantially improved as compared to conventional PVC products, by determining certain resins as main resins and controlling amounts of the used resins, in order to improve low-temperature flexibility, thereby providing charging cables with improved electrical and mechanical properties.

In one aspect, the present invention provides a charging cable with low-temperature flexibility and oil resistance, which may include a wire for supplying power, a wire for transferring signals and a sheath.

In one preferred aspect, the charging cable with superior low-temperature flexibility and oil resistance may comprise a wire configured to supply power coated with a coating composition (A) including (a1) an amount of about 20 to 80 part per hundred rubber (phr) of ethylene propylene rubber (EPR) having a Mooney viscosity of about 20 to 60, (a2) an amount of about 10 to 80 phr of a polyolefin resin (PO), (a3) an amount of about 10 to 50 phr of a filler, (a4) an amount of about 1 to 10 phr of a cross-linking aid, (a5) an amount of about 0.1 to 5 phr of an antioxidant, and (a6) an amount of about 0.1 to 5 phr of a lubricant; a wire configured to transfer a signal coated with a coating composition (B) comprising (b1) an amount of about 20 to 80 phr of polypropylene (PP), (b2) an amount of about 20 to 80 phr of styrene thermoplastic elastomer, (b3) an amount of about 10 to 50 phr of a filler, (b4) an amount of about 0.1 to 5 phr of an antioxidant, and (b5) an amount of about 0.1 to 5 phr of a lubricant; and a sheath coated with a sheath composition for wires (C) including (c1) an amount of about 50 to 90 phr of a thermoplastic polyurethane (TPU) having a melt index (MI) of about 30 to 50 g/10 min, (c2) an amount of about 10 to 50 phr of a styrene thermoplastic elastomer having a melt index (MI) of about 1 to 5 g/10 min, (c3) an amount of about 10 to 70 phr of a phosphorous-based flame retardant, (c4) an amount of about 1 to 10 phr of a flame retardant aid, (c5) an amount of about 0.1 to 5 phr of an antioxidant, (c6) an amount of about 0.1 to 5 phr of a UV absorbent and a stabilizer, and (c7) an amount of about 0.1 to 5 phr of a lubricant.

The filler (a3) or the filler (b3) suitably may comprise one or more selected from the group consisting of SiO₂, CaCO₃, Mg(OH)₂ and hydrotalcite.

The filler (a3) or the filler (b3) may be silane coated on a surface thereof.

The filler (a3) or the filler (b3) suitably may have a mean particle size of about 0.5 to 1μ.

The cross-linking aid (a4) suitably may comprise one or more selected from the group consisting of triallyl isocyanurate (TAIC), triallyl cyanurate (TAC) and trimethylolpropane-trimethacrylate (TMPTMA).

The antioxidant (a5) or the antioxidant (b4) suitably may be a phenol-based antioxidant, a metal deactivator, or a mixture thereof.

The lubricant (a6) or the lubricant (b5) suitably may comprise one or more selected from the group consisting of fluorine-based, silicon-based, amide-based, zinc-based and fatty acid-based lubricants.

The styrene thermoplastic elastomer (b2) suitably may comprise one or more selected from the group consisting of styrene ethylene butylene styrene (SEBS), styrene-butadiene-styrene block copolymer (SBS), and styrene-isoprene-styrene block copolymer (SIS).

The styrene thermoplastic elastomer (c2) preferably may be styrene ethylene butylene styrene (SEBS).

The antioxidant (c5) suitably may comprise one or more selected from the group consisting of a phenol-based antioxidant, a phosphorous-based antioxidant and a hydrolysis stabilizer.

The lubricant (c7) suitably may comprise a Montan wax-based lubricant, silicon-based lubricant, or a mixture thereof.

Further provided is a vehicle part that may comprise the charging cable as described herein.

Still further provided is a vehicle may comprise the charging cable as described herein.

In other aspect, the present invention provides a wire for supplying power comprising a coating composition (A). Preferably, the coating composition (A) may comprise: an amount of about 20 to 80 part per hundred rubber (phr) of ethylene propylene rubber (EPR) having a Mooney viscosity of about 20 to 60; an amount of about 10 to 80 phr of a polyolefin resin (PO); an amount of about 10 to 50 phr of a filler; an amount of about 1 to 10 phr of a cross-linking aid; an amount of about 0.1 to 5 phr of an antioxidant; and an amount of about 0.1 to 5 phr of a lubricant.

In another aspect, the present invention provides a wire for transferring a signal comprising a coating composition (B). Preferably, the coating composition (B) may comprise: an amount of about 20 to 80 phr of polypropylene (PP); an amount of about 20 to 80 phr of styrene thermoplastic elastomer; an amount of about 10 to 50 phr of a filler; an amount of about 0.1 to 5 phr of an antioxidant; and (b5) an amount of about 0.1 to 5 phr of a lubricant.

In another aspect, the present invention provide a sheath for a charging cable comprising a coating composition (C). Preferably, the coating composition (C) comprises: an amount of about 50 to 90 phr of a thermoplastic polyurethane (TPU) having a melt index (MI) of about 30 to 50 g/10 min; an amount of about 10 to 50 phr of a styrene thermoplastic elastomer having a melt index (MI) of about 1 to 5 g/10 min; an amount of about 10 to 70 phr of a phosphorous-based flame retardant; an amount of about 1 to 10 phr of a flame retardant aid; an amount of about 0.1 to 5 phr of an antioxidant; an amount of about 0.1 to 5 phr of a UV absorbent and a stabilizer; and an amount of about 0.1 to 5 phr of a lubricant.

In other aspects, the various compositions including the coating composition (A), the coating composition (B), and coating composition (C) may consist essentially of, essentially consist of or consist of the components as described above.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1A shows a cross-section of a charging cable of Comparative Example 4, and FIG. 1B shows a cross-section of an exemplary charging cable of Example 4 according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the FIGURES, reference numbers refer to the same or equivalent parts of the present invention throughout the several FIGURES of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the embodiment of the present invention will be described in detail with reference to the accompanying drawings to allow one skilled in the art to easily implement the present invention.

The present invention provides a coated charging cable including a wire for supplying power, a wire for transferring a signal and a sheath. Preferably, the wire for supplying power may be coated with a coating composition (A), the wire for transferring a signal may be coated with a coating composition (B) and the sheath may be coated with a sheath composition (C). Hereinafter, the respective components will be described in detail.

(1) Coating Composition (A)

The coating composition (A) for the wire, which is configured to supply power, may include: (a1) an amount of about 20 to 80 phr of ethylene propylene rubber (EPR) having a Mooney viscosity of about 20 to 60; (a2) an amount of about 10 to 80 phr of a polyolefin resin (PO); (a3) an amount of about 10 to 50 phr of a filler; (a4) an amount of about 1 to 10 phr of a cross-linking aid; (a5) an amount of about 0.1 to 5 phr of an antioxidant; and (a6) 0.1 to 5 phr of a lubricant.

The ethylene propylene rubber (EPR) (a1) as used herein may provide excellent flexibility and long-term insulation capacity. The EPR typically may be classified into a gum or pellet-type and may be suitably selected according to compound equipment. Preferably, EPR may be ethylene propylene diene monomer (EPDM). EPR suitably may have a Mooney viscosity of about 20 to 60. When the Mooney viscosity is less than about 20, mechanical properties may not be sufficiently improved, and when the Mooney viscosity is greater than about 30, extrusion property may not be sufficient for process. Accordingly, Mooney viscosity may preferably be within the above range.

In addition, the ethylene propylene rubber suitably may be included in an amount of about 20 to 80 phr. When EPR is present in an amount less than about 20 phr, flexibility may not be sufficiently provided due to high hardness, and when EPR is present in an amount greater than about 80 phr, deterioration in extrusion property and mechanical properties may occur. Thus, the ethylene propylene rubber may preferably be present within the above range.

The polyolefin resin (PO) (a2) as used herein may improve wire extrusion capability and tensile strength of the ethylene propylene rubber. The polyolefin resin (PO) suitably may include one or more selected from the group consisting of linear low-density polyethylene (LLDPE), low-density polyethylene (LDPE), very low-density polyethylene (VLDPE), medium-density polyethylene (MDPE) and polyethylene-octene elastomer (POE), and suitably may be used in an amount of about 10 to 80 phr. When the polyolefin resin is present in an amount less than about 10 phr, extrusion property may not be sufficient for manufacturing processing, and when the polyolefin resin is present in an amount greater than about 80 phr, flexibility may not be sufficiently obtained due to high hardness. Thus, the polyolefin resin may preferably be present within the above range.

The ethylene propylene rubber may be a rubber and thus sticky to another rubber, but ethylene propylene rubber may lose stickiness when blended with a polyolefin resin (PO) and molded into a pellet. In addition, when the ethylene propylene rubber is cross-linked at a high temperature 200±10° C. and at a high pressure 4-8 kgf/mm² after adding peroxide thereto, the surface may disadvantageously bulge or foam. The ethylene propylene rubber in the present invention may preferably be cross-linked using electron beam.

The filler (a3) as used herein may improve appearance and make outer diameter uniform during extrusion. The filler may include silane coated on the surface thereof. The filler suitably may include one or more selected from the group consisting of SiO₂, CaCO₃, Mg(OH)₂, and hydrotalcite and suitably may have a mean particle size of about 0.5 to 1 μm. When the mean particle size is less than about 0.5μ, dispersibility may not be sufficient, and when the mean particle size greater than about 1μ, wire surface may not be suitably obtained. Thus, the mean particle size may preferably be within the above range.

Furthermore, the filler suitably may be included in an amount of about 10 to 50 phr. When the filler is present in an amount of less than about 10 phr, there is a drawback of variation in outer diameter during extrusion, and when the filler is present in an amount greater than about 50 phr, deterioration in insulation resistance may occur. Thus, the filler may be preferably present in an amount within the above range.

The cross-linking aid (a4) may be used for electron beam cross-linking and may activate cross-linking sites during electron beam cross-linking and thereby improves cross-linking efficiency with a low energy. The cross-linking aid suitably may be selected from the group consisting of triallyl isocyanurate (TAIC), triallyl cyanurate (TAC) and trimethylolpropane-trimethacrylate (TMPTMA). The cross-linking aid suitably may be used in an amount of about 1 to 10 phr. When the cross-linking aid is used in an amount of less than about 1 phr, dispersibility may not be sufficient, and when the cross-linking aid is used in an amount greater than about 10 phr, blooming (whitening) on the wire surface may occur after extrusion. Preferably, the cross-linking aid may be included in an amount within the above range.

Furthermore, the antioxidant (a5) as used herein may prevent an insulation agent from aging during processing of raw materials and use. The antioxidant suitably may be a phenol-based antioxidant, a metal deactivator, or a mixture thereof. The phenol-based antioxidant may suitably include one or more selected from the group consisting of IRGANOX® 1010, IRGANOX® 1035, IRGANOX® 1076, IRGANOX® 1790 and IRGANOX® 1024.

Furthermore, the antioxidant suitably may be used in an amount of about 0.1 to 5 phr. When the antioxidant is used in an amount of less than about 0.1 phr, heat resistance may not be sufficiently improved, and when the antioxidant is used in an amount greater than about 5 phr, cross-linking may not be sufficiently obtained. Thus, the antioxidant preferably may be used in an amount within the above range.

The lubricant (a6) as used herein may improve dispersion during compounding and outer appearance during wire extrusion. The lubricant suitably may be selected from the group consisting of zinc-based and fatty acid-based lubricants, and suitably may be used in an amount of about 0.1 to 5 phr. When the lubricant is used in an amount less than about 0.1 phr, dispersibility may not be sufficiently obtained, and when the lubricant is used in an amount greater than about 5 phr, slipping may occur during extrusion and blooming (whitening) may occur on the wire surface after extrusion. Thus, the lubricant preferably may be used in an amount within the above range.

(2) Coating Composition (B)

The coating composition for a wire, which is configured to transfer a signal, may include: (b1) an amount of about 20 to 80 phr of polypropylene (PP); (b2) an amount of about 20 to 80 phr of a styrene thermoplastic elastomer; (b3) an amount of about 10 to 50 phr of a filler; (b4) an amount of about 0.1 to 5 phr of an antioxidant; and (b5) an amount of about 0.1 to 5 phr of a lubricant. Hereinafter, the respective components will be described in detail.

The polypropylene (PP) (b1) as used herein may prevent compression during wire assembly and sheath extrusion owing to hardness and high melting point (e.g. 163° C.).

Furthermore, to the thermoplastic elastomer may be used to prevent melting during sheath extrusion. For example, a blend of the polypropylene (b1) with a high molecular weight styrene thermoplastic elastomer (b2) may be used.

The polypropylene resin (b1) suitably may be one or more selected from the group consisting of block polypropylene (Block-PP), random polypropylene (random-PP), homo polypropylene (Homo-PP), and terpolymer polypropylene (Ter-PP).

In addition, the polypropylene resin suitably may be used in an amount of about 20 to 80 phr. When, the polypropylene resin is used in an amount less than about 20 phr, extrusion property may not be sufficient for manufacturing processing, and when the polypropylene resin is greater than about 80 phr, flexibility and cold resistance may not be sufficiently obtained due to high hardness. Preferably, the polypropylene resin may be present in an amount within the above range.

The styrene thermoplastic elastomer (b2) as used herein may improve low-temperature flexibility and prevent melting during sheath extrusion, and suitably may include one or more selected from the group consisting of styrene ethylene butylene styrene (SEBS), styrene-butadiene-styrene block copolymer (SBS), and styrene-isoprene-styrene block copolymer (SIS).

The styrene thermoplastic elastomer may be preferably used in an amount of about 20 to 80 phr. When the styrene thermoplastic elastomer is used in an amount of less than about 20 phr, flexibility may not be sufficiently obtained, and when the styrene thermoplastic elastomer is used in an amount greater than about 80 phr, extrusion property may not be sufficient for manufacturing processing. Preferably, the styrene thermoplastic elastomer is present in an amount within the above range.

The filler (b3) may be the same as the filler (a3) as used for the coating composition (A) of the wire for supplying power. In addition, the filler may preferably be used in an amount of about 10 to 50 phr. When the filler is used in an amount of less than about 10 phr, stability of outer diameter during extrusion may not be sufficient, and when the filler is used in an amount greater than about 50 phr, insulation resistance may not be sufficiently obtained. Preferably, the filler (b3) may be present in an amount within the above range.

In addition, the antioxidant (b4) may be the same as the antioxidant (a5) of the coating composition (A) for supplying power. In addition, the antioxidant suitably may be included in an amount of about 0.1 to 5 phr. When the antioxidant is used in an amount of less than about 0.1 phr, heat resistance stability may not be sufficiently obtained and when the antioxidant is used in an amount greater than about 5 phr, blooming (whitening) may occur on the wire surface after extrusion. Preferably, the antioxidant may be present in an amount within the above range.

The lubricant (b5) may be the same as the antioxidant (a6) of the coating composition (A) for supplying power. In addition, the lubricant suitably may be included an amount of about 0.1 to 5 phr. When the lubricant is used in an amount of less than about 0.1 phr, extrusion property may not be obtained for manufacturing processing, and when the lubricant is used in an amount greater than about 5 phr, slipping may occur during extrusion and blooming (whitening) may occur on the wire surface after extrusion. Thus, the lubricant may be used in an amount within the above range.

(3) Sheath (Coating) Composition (C)

The composition for coating the sheath (C) of the present invention may include: (c1) an amount of about 50 to 90 phr of thermoplastic polyurethane (TPU) having a melt index (MI) of about 30 to 50 g/10 min; (c2) an amount of about 10 to 50 phr of a styrene thermoplastic elastomer having a melt index (MI) of about 1 to 5 g/10 min; (c3) an amount of about 10 to 70 phr of a phosphorous-based flame retardant; (c4) an amount of about 1 to 10 phr of a flame retardant aid; (c5) an amount of about 0.1 to 5 phr of an antioxidant; (c6) an amount of about 0.1 to 5 phr of a UV absorbent and a stabilizer; and (c7) an amount of about 0.1 to 5 phr of a lubricant. Hereinafter, the respective components will be described in detail.

The thermoplastic polyurethane (TPU) (c1) as used herein may provide superior cold resistance, oil resistance, abrasion resistance and weatherability. Charging cables may be hardened upon use at low temperatures and are inconvenient. A blend of thermoplastic polyurethane (TPU) with styrene thermoplastic elastomer may satisfy low-temperature flexibility and thus relieve inconvenience of consumers.

Accordingly, the thermoplastic polyurethane (TPU) of the present invention suitably may be included in an amount of about 50 to 90 phr. When the thermoplastic polyurethane is used in an amount of less than about 50 phr, cold resistance, oil resistance, abrasion resistance and weatherability may not be sufficient, and when the thermoplastic polyurethane is used in an amount greater than about 90 phr, flexibility may not be sufficiently obtained due to matte and high hardness of the cable surface. Preferably, the thermoplastic polyurethane may be included within the above range.

In addition, the thermoplastic polyurethane (TPU) suitably may have a Shore A hardness of about 70, about 75, about 80, about 90 and about 95. The TPU suitably may have a melt index (MI), which is measured under conditions of 200° C./10 kg, of about 30 to 50 g/10 min. When the melt index is less than about 30 g/10 min, extrusion property may not be sufficient for manufacturing processing, and when the melt index is greater than about 50 g/10 min, mechanical properties and flowability upon compounding may not be sufficiently obtained. Thus, the melt index suitably may be within the above range.

The styrene thermoplastic elastomer (TPE) (c2) as used herein may impart low-temperature flexibility when mixed with the thermoplastic polyurethane (TPU) and preferably may be styrene ethylene butylene styrene (SEBS) due to its high polarity.

The styrene thermoplastic elastomer (TPE) suitably may be included in an amount of about 10 to 50 phr. When the styrene thermoplastic elastomer is present in an amount of less than about 10 phr, low-temperature flexibility and extrusion moldability may not be sufficiently obtained, and when the styrene thermoplastic elastomer is present in an amount greater than about 50 phr, mechanical properties and chemical property may not be sufficient. Thus, the styrene thermoplastic elastomer preferably may be used within the above range.

In addition, the styrene thermoplastic elastomer suitably may have a melt index (MI), which is measured under the conditions of about 230° C./5 kg, of about 1 to 5 g/10 min. When the styrene thermoplastic elastomer has a melt index of less than about 1 g/10 min extrusion property may not be sufficient for manufacturing process, and when the styrene thermoplastic elastomer has a melt index of greater than about 5 g/10 min, mechanical properties may not be sufficiently obtained resulting from deterioration in tensile strength. Thus, the melt index of the styrene thermoplastic elastomer may be within the above range.

The flame retardant (c3) of the present invention may be a halogen-free flame retardant and preferably may be a phosphorous-based flame retardant, because the phosphorous-based flame retardant has high compatibility with the thermoplastic polyurethane (TPU). The flame retardant suitably may be included in an amount of about 10 to 70 phr. When the flame retardant is used in an amount of less than about 10 phr, flame retardancy may not be sufficiently obtained, and when the flame retardant is used in an amount greater than about 70 phr, mechanical properties may not be sufficient and extrusion property may not be sufficient for manufacturing process. Thus, the flame retardant suitably may be included within the above range.

The flame retardant aid (c4) as used herein may improve flame retardancy of the phosphorous-based flame retardant. The flame retardant aid may be a nitrogen-based flame retardant and suitably may be included in an amount of about 1 to 10 phr. When the flame retardant aid is present in an amount of less than about 1 phr, dispersibility and flame retardancy may not be sufficient, and when the flame retardant aid is present in an amount greater than about 10 phr, extrusion property may not be sufficiently obtained for manufacturing process. Thus, the flame retardant preferably may be included within the above range.

In addition, the antioxidant (c5) may include one or more selected from the group consisting a phenol-based antioxidant, a phosphorous-based antioxidant and a hydrolysis stabilizer. The antioxidant suitably may be included in an amount of about 0.1 to 5 phr. When the antioxidant is present in an amount of less than about 0.1 phr, heat resistance may not be sufficient due to dispersibility and, when the antioxidant is present in an amount greater than about 5 phr, blooming (whitening) may occur on the wire surface after extrusion. Preferably, the antioxidant may be present in an amount within the above range.

The UV absorbent and stabilizer (c6) may absorb UV light to delay decomposition of polymers, and control activity of the absorbed UV light for stabilization. The UV absorbent and stabilizer suitably may be used in an amount of about 0.1 to 5 phr. When the UV absorbent and stabilizer are used in an amount of less than about 0.1 phr, UV stability may not be sufficient, and when the UV absorbent and stabilizer are used in an amount greater than about 5 phr, blooming (whitening) may occur on the wire surface after extrusion. Preferably, the UV absorbent and stabilizer may be included in an amount within the above range.

The lubricant (c7) as used herein may improve dispersibility during compounding, and may improve outer appearance during extrusion. The lubricant suitably may include a Montan wax lubricant, a silicon-based lubricant or a mixture thereof. The lubricant suitably may be included in an amount of about 0.1 to 5 phr. When the lubricant is used in an amount of less than about 0.1 phr, extrusion property (extrusion load), and when the lubricant is used in an amount greater than about 5 phr, slipping may occur during extrusion and blooming (whitening) may occur on the wire surface after extrusion. Preferably, the lubricant may be included in an amount within the above range.

The charging cable coated with the coating compositions as described above according to various exemplary embodiments of the present invention may satisfy 90° C. heat resistance in accordance with IEC 62893, and may provide superior mechanical properties such as low-temperature flexibility, cold resistance and oil resistance, chemical properties and electrical properties, thus being widely used as an electric vehicle charging cable.

### EXAMPLES

Hereinafter, the present invention will be described with reference to examples. The following examples illustrate the invention and are not intended to limit the same.

### Comparative Example 1 and Example 1: Wires for Supplying Power

### Comparative Examples 1-1 to 1-3

The components shown in the following Table 1 were mixed in ratios shown in Table 1 and were compounded into a pellet using a twin-screw extruder or a kneader. Wire samples for measuring physical properties were produced from the pellet using a single extruder.

TABLE 1
Coating composition used for the wire for supplying power (unit: phr)

| Items | | | | | Comparative | Comparative | Comparative |
|---|---|---|---|---|---|---|---|
| (unit: | | Example | Example | Example | Example | Example | Example |
| phr) | Composition | 1-1 | 1-2 | 1-3 | 1-1 | 1-2 | 1-3 |
| Resin | Ethylene propylene | 50 | 60 | 80 | 90 | 100 | 10 |
| | rubber (EPR) 1) | | | | | | |
| | Polyolefin resin 2) | 50 | 40 | 20 | 10 | — | 90 |
| Filler | Filler A 3) | 50 | 50 | 50 | 50 | 50 | 50 |
| Cross-linking | Cross-linking aid A 4) | 2 | 2 | 2 | 2 | 2 | 2 |
| aid | | | | | | | |
| Antioxidant | Antioxidant A 5) | 1 | 1 | 1 | 1 | 1 | 1 |
| | Antioxidant B 6) | 1 | 1 | 1 | 1 | 1 | 1 |
| Lubricant | Zn-amide-based lubricant 7) | 1 | 1 | 1 | 1 | 1 | 1 |
| | silicon-based lubricant 8) | 1 | 1 | 1 | 1 | 1 | 1 |

1) Product of EPDM containing 0.5% of ENB (product name: Nordel, manufacturer name: DOW)
2) POE (product name: Engage, manufacturer name: DOW)
3) Mg(OH)₂ filler, coated with silane and having a mean particle size of 1 micron (μ) (product name: H5A, manufacturer name: Albemarle)
4) Crosslinking aid (product name: Trim S, manufacturer name: Rainchem)
5) Phenol-based antioxidant (product name: IRGANOX1010, manufacturer name: BASF)
6) Metal deactivator (product name: IRGANOX1024, manufacturer name: BASF)
7) Zn-amide-based lubricant (product name: TR-016, manufacturer name: Structol)
8) Silicon-based lubricant (product name: Pellet S, manufacturer name: Wacker)

### Examples 1-1 to 1-3

Wire samples were produced in the same manner as described in Comparative Examples 1-1 to 1-3, but the wire samples were produced in accordance with the ratios shown in Table 1.

### Test Example 1: Measurement of Physical Properties

5 specimens of each of Comparative Examples 1-1 to 1-3, and Examples 1-1 to 1-3 were prepared, tensile strength, tensile residual stress, elongation residual stress, elongation (at low temperature) and hardness thereof were measured, and the resulting physical properties are shown in the following Table 2. The test method herein used will be described below.

(1) Measurement of tensile strength: measured in accordance with EN 60811-501.

(2) Measurement of tensile residual stress: measured in accordance with EN 60811-401.

(3) Measurement of elongation: measured in accordance with EN 60811-501.

(4) Measurement of elongation residual stress: measured in accordance with EN 60811-401.

(5) Measurement of elongation (at low temperature, e.g. −40° C.): measured in accordance with EN 60811-505.

(6) Measurement of hardness: measured in accordance with HD 605.

TABLE 2
Measurement results of physical properties

| | | | | | | Comparative | Comparative | Comparative |
|---|---|---|---|---|---|---|---|---|
| | Required | Test | Example | Example | Example | Example | Example | Example |
| Test items | values | conditions | 1-1 | 1-2 | 1-3 | 1-1 | 1-2 | 1-3 |
| Tensile | 8 N/mm² or | — | 14.7 | 11.8 | 8.5 | 7.1 | 6.5 | 20.2 |
| strength | more | | | | | | | |
| Tensile | Variation of | 135° C. × | 2 | 3 | 5 | 3 | 2 | 3 |
| residual stress | 30% or less | 7 day | | | | | | |
| (Aged) | | | | | | | | |
| Elongation | 200% or more | — | 500 | 550 | 610 | 630 | 650 | 450 |
| Elongation | variation of | 135° C. × | 8 | 8 | 13 | 18 | 20 | 8 |
| residual stress | 30% or less | 7 day | | | | | | |
| (Aged) | | | | | | | | |
| Elongation (at | elongation: | −40° C. | 400 | 400 | 400 | 400 | 400 | 400 |
| low | 30% or more | | | | | | | |
| temperature) | | | | | | | | |
| Hardness | Shore A of 80 | — | 85 | 82 | 80 | 65 | 60 | 99 |
| | or more, or 90 | | | | | | | |
| | or less | | | | | | | |

As shown in Table 2 above, Examples 1-1 to 1-3 according to the exemplary embodiments of the present invention satisfied all of hardness and mechanical properties based on suitable use of the respective components, as compared to Comparative Examples 1-1 to 1-3 which were not within the range of the present invention.

### Comparative Example 2 and Example 2: Wire for Transferring a Signal

### Comparative Examples 2-1 to 2-2

The components shown in the following Table 3 were mixed in ratios shown in Table 3 and compounded into a pellet using a twin-screw extruder or a kneader. Wire samples for measuring physical properties were produced from the pellets using a single extruder.

### Examples 2-1 to 2-4

Wire samples were produced in the same manner as described in Comparative Examples 2-1 to 2-3, but the wire samples were produced in accordance with the ratios shown in the following Table 3.

TABLE 3
Coating composition used for the wire for transferring a signal (unit: phr)

| | | | | | | Comparative | Comparative |
|---|---|---|---|---|---|---|---|
| Items | | Example | Example | Example | Example | Example | Example |
| (unit: phr) | Composition | 2-1 | 2-2 | 2-3 | 2-4 | 2-1 | 2-2 |
| Resin | Polypropylene resin 1) | 60 | 50 | 40 | 30 | 10 | 90 |
| | Styrene | 40 | 50 | 60 | 70 | 90 | 10 |
| | thermoplastic | | | | | | |
| | elastomer 2) | | | | | | |
| Filler | Filler A 3) | 50 | 50 | 50 | 50 | 50 | 50 |
| Antioxidant | Antioxidant A 4) | 1 | 1 | 1 | 1 | 1 | 1 |
| | antioxidant B 5) | 1 | 1 | 1 | 1 | 1 | 1 |
| Lubricant | Zn-amide-based | 1 | 1 | 1 | 1 | 1 | 1 |
| | lubricant 6) | | | | | | |
| | Silicon-based | 1 | 1 | 1 | 1 | 1 | 1 |
| | lubricant 7) | | | | | | |

1) Block-PP (product name: SB-930, manufacturer name: Lotte Chemical)
2) SEBS (product name: G1651, manufacturer name: Kraton)
3) Mg(OH)2 filler, coated with silane and having a mean particle size of 1 micron (μ) (product name: H5A, manufacturer name: Albemarle)
4) Phenol-based antioxidant (product name: IRGANOX1010, manufacturer name: BASF)
5) Metal deactivator (product name: IRGANOX1024, manufacturer name: BASF)
6) Zn-amide-based lubricant (product name: TR-016, manufacturer name: Structol)
7) silicon-based lubricant (product name: Pellet S, manufacturer name: Wacker)

### Test Example 2: Measurement of Physical Properties

5 specimens of each of Comparative Examples 2-1 to 2-2, and Examples 2-1 to 2-4 were prepared, tensile strength, tensile residual stress, elongation residual stress, elongation (at low temperature) and hardness thereof were measured, and the resulting physical properties are shown in the following Table 4.

TABLE 4
Measurement results of physical properties

| | | | | | | | Comparative | Comparative |
|---|---|---|---|---|---|---|---|---|
| | Required | Test | Example | Example | Example | Example | Example | Example |
| Test items | values | conditions | 2-1 | 2-2 | 2-3 | 2-4 | 2-1 | 2-2 |
| Tensile | 15 N/mm² | — | 20.6 | 17.6 | 16.0 | 15.1 | 11.2 | 25.7 |
| strength | or more | | | | | | | |
| Tensile | Variation | 135° C. × | 10 | 23 | 24 | 25 | 28 | 8 |
| residual stress | of 30% | 7 day | | | | | | |
| (Aged) | or less | | | | | | | |
| Elongation | 300% or | — | 600 | 650 | 700 | 760 | 860 | 450 |
| | more | | | | | | | |
| Elongation | Variation | 135° C. × | 12 | 21 | 28 | 30 | 35 | 10 |
| residual stress | of 30% | 7 day | | | | | | |
| (Aged) | or less | | | | | | | |
| Elongation (at | Elongation: | −40° C. | 365 | 400 | 400 | 400 | 400 | 300 |
| low | 30% | | | | | | | |
| temperature) | or more | | | | | | | |
| Hardness | Shore D | — | 56 | 55 | 53 | 50 | 25 | 69 |
| | of 50 or | | | | | | | |
| | more, 60 | | | | | | | |
| | or less | | | | | | | |

As shown in Table 4 above, Example 2-1 according to the exemplary embodiments of the present invention satisfied all of hardness and mechanical properties based on suitable use of the respective components, as compared to Comparative Examples 2-1 to 2-2 which were not within the range of the present invention.

### Comparative Example 3 and Example 3: Sheath

### Comparative Examples 3-1 to 3-3

The components shown in the following Table 5 were mixed in ratios shown in Table 5 and compounded into a pellet using a twin-screw extruder or a kneader. Wire samples for measuring physical properties were produced from the pellet using a single extruder.

### Examples 3-1 to 3-3

Wire samples were produced in the same manner as described in Comparative Examples 3-1 to 3-3, but the wire samples were produced in accordance with the ratios shown in the following Table 5.

TABLE 5
Sheath composition for wires (unit: phr)

| | | | | | Comparative | Comparative | Comparative |
|---|---|---|---|---|---|---|---|
| Items (unit: | | Example | Example | Example | Example | Example | Example |
| phr) | Composition | 3-1 | 3-2 | 3-3 | 3-1 | 3-2 | 3-3 |
| Resin | Thermoplastic | 60 | 50 | 90 | 40 | 30 | 95 |
| | polyurethane | | | | | | |
| | (TPU) 1) | | | | | | |
| | Styrene | 40 | 50 | 10 | 60 | 70 | 5 |
| | thermoplastic | | | | | | |
| | elastomer 2) | | | | | | |
| Flame | Phosphorous-based | 50 | 50 | 50 | 50 | 50 | 50 |
| retardant | flame retardant 3) | | | | | | |
| Flame | Nitrogen-based | 10 | 10 | 10 | 10 | 10 | 10 |
| retardant aid | flame retardant 4) | | | | | | |
| Antioxidants | Phenol-based | 1 | 1 | 1 | 1 | 1 | 1 |
| | antioxidant 5) | | | | | | |
| | Phosphorous-based | 1 | 1 | 1 | 1 | 1 | 1 |
| | antioxidant 6) | | | | | | |
| | Hydrolysis | 1 | 1 | 1 | 1 | 1 | 1 |
| | stabilizer 7) | | | | | | |
| UV stabilizers | UV absorbent 8) | 0.5 | 0.5 | 0.5 | 0.5 | 0.5 | 0.5 |
| | UV stabilizer 9) | 0.5 | 0.5 | 0.5 | 0.5 | 0.5 | 0.5 |
| Lubricants | Montan-based | 1 | 1 | 1 | 1 | 1 | 1 |
| | lubricant 10) | | | | | | |
| | Silicon-based | 1 | 1 | 1 | 1 | 1 | 1 |
| | lubricant 11) | | | | | | |

1) Thermoplastic polyurethane resin having a melt index (MI) of 30 to 50 g/10 min (product name: Elastollan, manufacturer name: BASF)
2) Styrene thermoplastic elastomer having a melt index (MI) of 1 to 5 g/10 min (product name: Kraton G, manufacturer name: Kraton)
3) Phosphorous-based flame retardant (product name: OP-930, manufacturer name: Clariant)
4) Nitrogen-based flame retardant (product name: MC-110, manufacturer name: UNIVERSAL CHEMTECH)
5) Phenol-based antioxidant (product name: IRGANOX1010, manufacturer name: BASF)
6) Phosphorous-based antioxidant(product name: IRGANOX1024, manufacturer name: BASF)
7) hydrolysis stabilizer (product name: Stabaxol P, manufacturer name: Rainchem)
8) UV absorbent (product name: LL28, manufacturer name: Addivant)
9) UV stabilizer (product name: LL62, manufacturer name: Addivant)
10) Montan-based lubricant (product name: CERIDUST 5551, manufacturer name: Clariant)
11) Silicon-based lubricant (product name: Pellet S, manufacturer name: Wacker)

### Test Example 3: Measurement of Physical Properties

5 specimens of each of Comparative Examples 3-1 to 3-3, and Examples 3-1 to 3-3 were prepared, tensile strength, tensile residual stress, elongation residual stress, oil resistance, elongation (at low temperature, e.g. −40° C.) and heat impact thereof were measured, and the resulting physical properties are shown in the following Table 6. The test method will be described below.

(1) Measurement of tensile strength: measured in accordance with EN 60811-501.

(2) Measurement of tensile residual stress: measured in accordance with EN 60811-401.

(3) Measurement of elongation: measured in accordance with EN 60811-501.

(4) Measurement of elongation residual stress: measured in accordance with EN 60811-401.

(5) Measurement of oil resistance: measured in accordance with EN 60811-404.

(6) Measurement of elongation (at low temperature, e.g. −40° C.): measured in accordance with EN 60811-505.

(7) Heat impact: measured in accordance with EN 60811-509.

TABLE 6
Measurement results of physical properties

| | | | | | | Comparative | Comparative | Comparative |
|---|---|---|---|---|---|---|---|---|
| | Required | Test | Example | Example | Example | Example | Example | Example |
| Test items | values | conditions | 3-1 | 3-2 | 3-3 | 3-1 | 3-2 | 3-3 |
| Tensile | 20 N/mm² | — | 23.7 | 20.1 | 30.7 | 14.9 | 13.4 | 33.5 |
| strength | or more | | | | | | | |
| Tensile | Variation | 110° C. × | 6 | 13 | 4 | 31 | 45 | 3 |
| residual stress | of 30% or | 7 day | | | | | | |
| (Aged) | less | | | | | | | |
| Elongation | 300% or | — | 514 | 570 | 320 | 640 | 720 | 290 |
| | more | | | | | | | |
| Elongation | Variation | 110° C. × | 6 | 14 | 5 | 17 | 15 | 6 |
| residual stress | of 30% or | 7 day | | | | | | |
| (Aged) | less | | | | | | | |
| Oil resistance | Tension | IRM902 | 28 | 35 | 14 | 50 | 60 | 12 |
| | variation | 100° C. × | | | | | | |
| | of 40% or | 7 day | | | | | | |
| | less | | | | | | | |
| | Elongation | | 3 | 12 | 2 | 4 | 5 | 3 |
| | variation | | | | | | | |
| | of 30% or | | | | | | | |
| | less | | | | | | | |
| Elongation | Elongation | −40° C. | 380 | 400 | 250 | 395 | 398 | 250 |
| (at low | of 30% | | | | | | | |
| temperature) | or more | | | | | | | |
| Heat impact | No crack | 150° C. × | Pass | Pass | Pass | Pass | Pass | Pass |
| | | 1 h | | | | | | |

As shown in Table 6 above, Examples 3-1 to 3-3 according to the exemplary embodiments of the present invention were suitable for use under low temperature conditions due to low-temperature flexibility and cold resistance, prevented permeation of oil for vehicles due to excellent oil resistance, and exhibited excellent mechanical properties such as tensile strength, based on suitable components in the coating compositions according to the exemplary embodiments of the present invention, as compared to Comparative Examples 3-1 to 3-3 which were not within the range of the present invention.

Accordingly, the thickness of the sheath may be reduced due to superior electrical, mechanical and chemical properties, the size and weight of charging cables may be reduced and the charging cables may be thus used instead of conventional wires coated with polyvinylchloride (PVC).

### Example 4: Charging Cable

The charging cable was produced from the composition which exhibited the most superior measurement results of physical properties among Test Examples 1 to 3. The composition of Example 1-1 was coated on a 2.5 SQ conductor to produce three wires for supplying power, and the composition of Example 2-1 was coated on a 0.5 SQ conductor to produce one wire for transferring a signal. All of the four produced wires were assembled and the assembly was coated with the composition of Example 3-1 to produce charging cable samples.

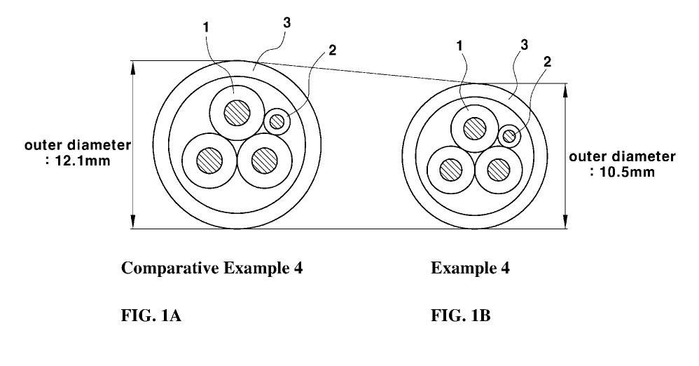

For reference, an exemplary cross-section of an exemplary charging cable is shown in FIG. 1B and the charging cable includes three wires for supplying power (1), one wire for transferring a signal (2) and a sheath (3) formed on an outer surface of the cable including the wires.

### Test Example 5: Measurement of Physical Properties

The charging cable sample of Example 4 was evaluated based on ICE 62893 and evaluation results are shown in the following Table 7.

TABLE 7
Evaluation results based on ICE 62893

| | | | Required values and test | Measurement |
|---|---|---|---|---|
| Test items | | | conditions | results |
| Wires | Tensile | 0.5 SQ | 15 N/mm² | 27.35 |
| | strength | 2.5 SQ | 8 N/mm² | 13.07 |
| | Elongation | 0.5 SQ | 300% or more | 526 |
| | | 2.5 SQ | 200% or more | 476 |
| | Heating tensile | 0.5 SQ | Variation of 30% or less | 2.8 |
| | residual stress | | (135° C. X 7 day) | |
| | Heating | 2.5 SQ | Variation of 30% or less | 4 |
| | elongation | | (135° C. X 7 day) | |
| | residual stress | | | |
| | Low-temperature | 0.5 SQ | 30% or more (−40° C.) | 360 |
| | elongation | 2.5 SQ | 30% or more (−40° C.) | 400 |
| | Insulation | 2.5 SQ | 0.691 MΩKm or more | 120 |
| | resistance | | | |
| | (90° C.) | | | |
| Sheath | Tensile strength | | 20 N/mm² | 24.2 |
| | Elongation | | 300% or more | 514 |
| | Heating tensile residual stress | | variation of 30% or less | 6 |
| | | | (120° C. X 7 day) | |
| | Heating elongation residual stress | | variation of 30% or less | 6 |
| | | | (120° C. X 7 day) | |
| | Oil-resistant tensile residual stress | | variation of 40% or less | 28 |
| | | | (IRM 902 100° C. X 7 day) | |
| | Oil-resistant elongation residual stress | | variation 30% or less | 3 |
| | | | (IRM 902 100° C. X 7 day) | |
| | Low-temperature elongation | | 30% or more (−40° C.) | 380 |
| | Bending Test for Sheath | | Observation of cracks after 4- or | Pass |
| | (at −40° C.) | | 5-times rolling sample having a | |
| | | | rod diameter, twice | |
| | Abrasion resistance | | 4,000 mm or more upon | 5532 mm |
| | | | application of a 400 g load | |
| Wire cable | Flexibility | Room temperature | 10N or less | 8 |
| (Finished | | (23° C.) | | |
| product) | | Low temperature | 37N or less | 16 |
| | | (−40° C.) | | |

As shown in Table 7, the charging cable of Example 4 produced using the coating composition according to an exemplary embodiment of the present invention satisfied all requirements of ICE 62983.

Accordingly, the coating compositions according to various exemplary embodiments of the present invention, and the wires and sheath coated with the compositions exhibited physical properties such as low-temperature flexibility, cold resistance, oil resistance, and abrasion resistance as well as electrical properties.

### Comparative Example 4: Conventional Charging Cable Coated with Polyvinylchloride (PVC)

A conventional charging cable (manufacturer: EVJT, product name: KYUNGSHIN CABLE) was prepared. This uses a polyvinylchloride (PVC) resin as a material for the wires and the sheath.

### Test Example 6: Measurement of Physical Properties

5 specimens of each charging cable of Example 4 and Comparative Example 4, were prepared, mechanical properties (tensile strength and elongation at room temperature, tension variation, elongation variation and abrasion resistance at high temperature), electrical property (insulation resistance), and chemical property (oil resistance) were measured, and the resulting physical properties are shown in the following Table 8. The test method herein used will be described below.

(1) Measurement of tensile strength/elongation (at room temperature 23° C.): the capacity of a charging cable to withstand an applied load or pulling. Regarding the shapes of the charging cable specimens, insulators with an inner diameter of less than 5 mm have a tubular shape and other insulators have a dumbbell shape. The tubular specimens have a length of about 100 mm and gradations at a gap of 20 mm in the center thereof. The dumbbell-shaped specimens were prepared by removing a conductor by a suitable method and making the surface flat. At this time, the dumbbell-shaped specimens should have a thickness of not less than 0.8 mm and not greater than 2.0 mm. The dumbbell-shaped specimens were punched by a No. 3 or 4 dumbbell and have gradations at a gap of 20 mm in the center thereof. Testing was conducted using a tension tester, the prepared specimen was held, and a maximum tensile load and the length of gradations upon cutting were measured after pulling at a rate of 250 mm/min. The measurement values were converted into tensile strength and elongation in accordance with the equations set forth in the following Table 8. An average of the five converted values was obtained as a resulting value.

TABLE 8

| Calculation of cross-sectional area | | | |
|---|---|---|---|
| | Method using | Calculation | |
| Method | density, weight and | of tensile | Calculation of |
| using sizes | length | strength | elongation |
| $A = \frac{π}{4} ( {D}^{2} - {d}^{2} )$ A: cross-sectional area (mm²) D: outer diamter (mm) d: inner diamter (mm) | $A = \frac{1000 \times m}{ρ \times 1}$ A: cross-sectional area (mm²) m: weight (kg) l: length (mm) ρ: density (g/cm²) | $α = \frac{F}{A}$ α: Tensile strength (MPa) F: Maximum tensile load (kg) A: cross- sectional area of specimen | $ε = \frac{{I}_{1} - {I}_{0}}{{I}_{0}} \times 100$ ε: elongation (%) l₁: length of gradation upon cutting (mm) l₀: length of gradation (mm) |

(2) Measurement of heat resistance: heat resistance was measured to evaluate lifespan of wire, more specifically, to evaluate high-temperature resistance according to inner/outer environments under harsher conditions than actual operating conditions. The charging cable specimens were placed in a 120° C. constant-temperature bath for 168 hours. At this time, the specimens were away from the inner surface of the constant-temperature bath by a distance of 20 mm or greater and was not tested with samples composed of other materials.

(3) Measurement of abrasion resistance: resistance of insulators against exterior rough plane, load and frictional force was measured. Specifically, a charging cable specimen with a length of about 900 mm was prepared, fixed to an abrasion resistance tester with a tape and was brought into contact with the abrasion resistance tape. A predetermined load (400 g) was applied, the tape was transferred at a rate of 1,500 mm/min and the length of the tape when the conductor contacts the tape was read. After measurement was conducted at one point, the sample was moved 25 mm, rotated at an angle of 90° and fixed and the previous test was repeated. By the method described above, an average of four values, which were obtained from one sample, was determined as an abrasion resistance value.

(4) Measurement of insulation resistance: measured using an insulation resistance tester (4339B, Agilent).

(5) Measurement of oil resistance: charging cable specimens were immersed in an IRM902 oil in an oil-resistant bath at 100° C. for 240 hours. The tensile strength and elongation of the immersed charging cable were measured in the same manner as in measurement of tensile strength/elongation.

(6) Measurement of flexibility: flexibility testing was conducted to measure force required to bend the cable and maintain flexibility of a high-flexibility cable. A charging cable specimen of 400 mm or longer was fixed such that the radius thereof reached 80 mm, a load cell was dropped at a rate of 100 mm/min and a maximum load until a bending radius reached 40 mm was measured.

TABLE 9
Measurement results of physical properties

| | | | | Comparative | | |
|---|---|---|---|---|---|---|
| Items | | | Unit | Example 4 | Example 4 | Details |
| Mechanical | Room temperature | Tensile | N/mm² | 16 | 24.2 | 51% ▴ |
| property | (23° C.) | strength | | | | |
| (sheath) | | Elongation | % | 188 | 514 | 173% ▴ |
| | Heat resistance | Tension | % | 15 | 6 | 60% ▴ |
| | (120° C.) | variation | | | | |
| | | Elongation | % | 10 | 6 | 40% ▴ |
| | | variation | | | | |
| | Abrasion resistance | | mm | 4228 | 5532 | 38% ▴ |
| Electrical | Insulation resistance | | MΩKm | 0.335 | 120 | 357% ▴ |
| property | (90° C.) | | | | | |
| (wire) | | | | | | |
| Chemical | Oil | Tension | % | 37 | 28 | 24% ▴ |
| property | resistance | variation | | | | |
| (sheath) | | Elongation | % | 30 | 3 | 90% ▴ |
| | | variation | | | | |

TABLE 10
Measurement results of physical properties

| | | Comparative | | |
|---|---|---|---|---|
| Items | | Example 4 | Example 4 | Details |
| Flexibility | Room temperature | 10 | 8 | 20% ▴ |
| (N) | (23° C.) | | | |
| | Low temperature | 37 | 16 | 57% ▴ |
| | (−40° C.) | | | |

As shown in Table 9, Example 4 according to an exemplary embodiment of the present invention exhibited superior mechanical properties such as tensile strength and elongation at room temperature, as well as tension variation and elongation variation under harsh heating conditions, as compared to Comparative Example 4 (conventional charging cable) coated with PVC. In particular, elongation was greatly increased by 173% and other physical properties were also increased by 40 to 60%.

In addition, regarding the chemical property of oil resistance in Example 4, tension variation was increased by 24% and elongation variation was increased by 90%, as compared to Comparative Example 4 (conventional charging cable). In particular, there was almost no elongation variation.

In addition, when insulation resistance was measured as an electrical property, Example 4 exhibited high insulation resistance, which was increased by 357%, as compared to Comparative Example 4.

As shown in Table 10, Example 4 exhibited superior flexibility, in particular, much superior flexibility at a low temperature, than Comparative Example 4.

Accordingly, the charging cable according to various exemplary embodiments of the present invention, which includes eco-friendly wire and satisfies low-temperature flexibility as well as mechanical properties, chemical properties and electrical properties, can be provided as an electric vehicle charging cable capable of offering further reliability to users.

Accordingly, the coating compositions according to various exemplary embodiments of the present invention for coating the wires or the sheath may provide superior extrusion moldability and charging cables for electric vehicles produced therefrom may be suitable for use under low-temperature conditions because of low temperature flexibility, cold resistance, and bendability.

In addition, the charging cables according to various exemplary embodiments of the present invention for electric vehicles may prevent permeation of oil for vehicles due to substantially improved outer appearance and oil resistance and may be safely mounted or installed in vehicles for use. Moreover, the cables may be recycled in accordance with eco-friendly vehicle components trend. Since the charging cables of the present invention do not contain a halogen-based flame retardant, and are eco-friendly, secure heat resistance corresponding to a temperature of about 90° C. wires for vehicles, and have mechanical strength, heat resistance and UV stability, they may be used as an alternative to conventional wires coated with polyvinylchloride (PVC).

In addition, the charging cables according to various exemplary embodiments of the present invention may realize superior insulation and reduction of the thickness of the sheath, as compared to conventional wires coated with polyvinylchloride (PVC) due to excellent electrical and mechanical properties, thus advantageously providing small and lightweight products.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A charging cable with low-temperature flexibility and oil resistance, comprising:
a wire, configured to supply power, coated with a coating composition (A) comprising: (a1) an amount of about 20 to 80 part per hundred rubber (phr) of ethylene propylene rubber (EPR) having a Mooney viscosity of about 20 to 60; (a2) an amount of about 10 to 80 phr of a polyolefin resin (PO); (a3) an amount of about 10 to 50 phr of a filler; (a4) an amount of about 1 to 10 phr of a cross-linking aid; (a5) an amount of about 0.1 to 5 phr of an antioxidant; and (a6) an amount of about 0.1 to 5 phr of a lubricant;
a wire, configured to transfer a signal, coated with a coating composition (B) comprising: (b1) an amount of about 20 to 80 phr of polypropylene (PP); (b2) an amount of about 20 to 80 phr of styrene thermoplastic elastomer; (b3) an amount of about 10 to 50 phr of a filler; (b4) an amount of about 0.1 to 5 phr of an antioxidant; and (b5) an amount of about 0.1 to 5 phr of a lubricant; and
a sheath coated with a sheath composition (C) comprising: (c1) an amount of about 50 to 90 phr of a thermoplastic polyurethane (TPU) having a melt index (MI) of about 30 to 50 g/10 min; (c2) an amount of about 10 to 50 phr of a styrene thermoplastic elastomer having a melt index (MI) of about 1 to 5 g/10 min; (c3) an amount of about 10 to 70 phr of a phosphorous-based flame retardant; (c4) an amount of about 1 to 10 phr of a flame retardant aid; (c5) an amount of about 0.1 to 5 phr of an antioxidant; (c6) an amount of about 0.1 to 5 phr of a UV absorbent and a stabilizer; and (c7) an amount of about 0.1 to 5 phr of a lubricant.

2. The charging cable according to claim 1, wherein the filler (a3) or the filler (b3) comprises one or more selected from the group consisting of SiO₂, CaCO₃, Mg(OH)₂ and hydrotalcite.

3. The charging cable according to claim 1, the filler (a3) or the filler (b3) comprises silane coated on a surface thereof.

4. The charging cable according to claim 1, the filler (a3) or the filler (b3) has a mean particle size of about 0.5 to 1μ.

5. The charging cable according to claim 1, wherein the cross-linking aid (a4) comprises one or more selected from the group consisting of triallyl isocyanurate (TAIC), triallyl cyanurate (TAC) and trimethylolpropane-trimethacrylate (TMPTMA).

6. The charging cable according to claim 1, wherein the antioxidant (a5) or the antioxidant (b4) comprises a phenol-based antioxidant, a metal deactivator, or a mixture thereof.

7. The charging cable according to claim 1, wherein the lubricant (a6) or the lubricant (b5) comprises one or more selected from the group consisting of fluorine-based, silicon-based, amide-based, zinc-based and fatty acid-based lubricants.

8. The charging cable according to claim 1, wherein the styrene thermoplastic elastomer (b2) comprises one or more selected from the group consisting of styrene ethylene butylene styrene (SEBS), styrene-butadiene-styrene block copolymer (SBS), and styrene-isoprene-styrene block copolymer (SIS).

9. The charging cable according to claim 1, wherein the styrene thermoplastic elastomer (c2) is styrene ethylene butylene styrene (SEBS).

10. The charging cable according to claim 1, wherein the antioxidant (c5) comprises one or more selected from the group consisting of a phenol-based antioxidant, a phosphorous-based antioxidant and a hydrolysis stabilizer.

11. The charging cable according to claim 1, wherein, the lubricant (c7) comprises a Montan wax-based lubricant, silicon-based lubricant, or a mixture thereof.

12. A vehicle part comprising a charging cable of claim 1.

13. A vehicle comprising a charging cable of claim 1.

14. A wire for supplying power comprising a coating composition,
wherein the coating composition comprises: an amount of about 20 to 80 part per hundred rubber (phr) of ethylene propylene rubber (EPR) having a Mooney viscosity of about 20 to 60; an amount of about 10 to 80 phr of a polyolefin resin (PO); an amount of about 10 to 50 phr of a filler; an amount of about 1 to 10 phr of a cross-linking aid; an amount of about 0.1 to 5 phr of an antioxidant; and an amount of about 0.1 to 5 phr of a lubricant.

15. A wire for transferring a signal comprising a coating composition,
wherein the coating composition comprises: an amount of about 20 to 80 phr of polypropylene (PP); an amount of about 20 to 80 phr of styrene thermoplastic elastomer; an amount of about 10 to 50 phr of a filler; an amount of about 0.1 to 5 phr of an antioxidant; and (b5) an amount of about 0.1 to 5 phr of a lubricant.

16. A sheath for a charging cable comprising a coating composition,
the coating composition comprises: an amount of about 50 to 90 phr of a thermoplastic polyurethane (TPU) having a melt index (MI) of about 30 to 50 g/10 min; an amount of about 10 to 50 phr of a styrene thermoplastic elastomer having a melt index (MI) of about 1 to 5 g/10 min; an amount of about 10 to 70 phr of a phosphorous-based flame retardant; an amount of about 1 to 10 phr of a flame retardant aid; an amount of about 0.1 to 5 phr of an antioxidant; an amount of about 0.1 to 5 phr of a UV absorbent and a stabilizer; and an amount of about 0.1 to 5 phr of a lubricant.
